(19) United States
(12) Patent Application Publication
(10) Pub. No.: US 2016/0167576 A1
(43) Pub. Date: Jun. 16, 2016

(54) AUTOMOBILE WARNING STRUCTURE

(71) Applicant: KUO-JEN LEE, TAINAN CITY (TW)

(72) Inventor: KUO-JEN LEE, TAINAN CITY (TW)

(21) Appl. No.: 14/568,371

(22) Filed: Dec. 12, 2014

(51) Int. Cl. B60Q 7/00

(52) U.S. Cl. CPC B60Q 7/00

(57) ABSTRACT

The invention relates to an automobile warning structure, comprising a blanket body. A warning pattern is disposed on the blanket body, and a plurality of holes disposed on a periphery of the blanket body. The blanket body can be fixed on a rear of an automobile by passing a rope, a hook or a combination thereof, through the plural holes, for connection purposes. In addition, the blanket body has waterproof and warmth retention functions, and can be further used as a commercial advertisement, a projection curtain or a car kit for covering and protecting an automobile.

### BACKGROUND OF THE INVENTION

1. Fields of the invention

The present invention relates to an automobile warning structure, which especially has functions of warning, waterproof, warmth retention, advertising, projection, or the like.

2. Descriptions of Related Art

When a car accident happened due to uneven roads, unexpected or undesired traffic, bad weather, driver's behaviors or other similar causes, road occupants and vehicles travelling behind the car accident should be reminded to pay more attention to the accident scene, by noting warning signs or devices the drivers of the vehicles in the accident placed at a safe distance from the car accident, so as to understand that the vehicles in the accident would wait for repair. Therefore, placing a warning sign or device at a safe distance from the car accident is a common sense for drivers to notify road occupants or vehicles of a car accident occurred ahead thereof. Generally, a warning tripod composed of a triangular sheet body, on which a reflective sticker is affixed for warning purposes, and a foldable leg, is prepared in the automobile.

Due to a limited volume of a conventional warning tripod, it cannot attract attention and alertness of road occupants and vehicles travelling behind a car accident, damage events or the like, particularly as used in a highway with a huge traffic flow, at night or in heavy fog, so the same accidents or events would occur again and again.

### SUMMARY OF THE INVENTION

In view of the above-mentioned problems, the object of the present invention is to provide an automobile warning structure. It is an automobile warning structure with functions of warning, waterproof, warmth retention, advertising, projection, and automobile protection.

Disclosed herein is an automobile warning structure having a blanket body. The blanket body has a warning pattern disposed thereon and a plurality of holes disposed on a periphery thereof, wherein the blanket body can be fixed on a rear of an automobile by passing a rope, a hook or a combination thereof, through the plural holes, for connection purposes. As a result, this invention allows drivers to fully beware of warning information of the blanket body, for purposes of warning and anti-collision.

According to an embodiment of the present invention, the blanket body made of a waterproof material and allows a user to use as a raincoat.

According to an embodiment of the present invention, the blanket body made of a warmth retention material.

According to an embodiment of the present invention, the blanket body has a second surface, oppose to a first surface on which the warning pattern is disposed, to be used as a commercial advertising curtain or a projection curtain.

According to an embodiment of the present invention, light emitting elements are disposed on the first surface to illuminate at night or in a dark condition, for attracting much more attention of drivers.

According to the above description, in comparison with the traditional technique, an automobile warning structure according to the present invention has the advantages as following:

1. The automobile warning structure of the present invention has a large visual warning area, so as to allow drivers to fully beware warning information thereof for purposes of warning and anti-collision.

2. The automobile warning structure of the present invention shows waterproof and warmth retention functions as being used a raincoat or warmth retention clothing.

3. The automobile warning structure of the present invention can be fitted with light emitting elements on the first surface thereof for illumination at night or in a dark condition, so as to attract much more drivers' attention thereto.

4. The automobile warning structure of the present invention has a second surface to be used as a commercial advertisement, a projection curtain or a car kit for covering and protecting the automobile.

### BRIEF DESCRIPTION OF THE DRAWINGS

FIG. 1 is a perspective view showing an embodiment of an automobile warming structure according to the present invention;

FIG. 2 is a schematic diagram showing ropes passing through a blanket body according to the present invention;

FIG. 3 is a schematic diagram showing hooks passing through a blanket body according to the present invention;

FIG. 4 is a schematic diagram of the present invention in use;

FIG. 5 is a schematic diagram showing another embodiment according to the present invention.

### DETAILED DESCRIPTION OF THE PREFERRED EMBODIMENT

Hereinafter, an exemplary embodiment of the present invention will be described in detail with reference to the accompanying drawings.

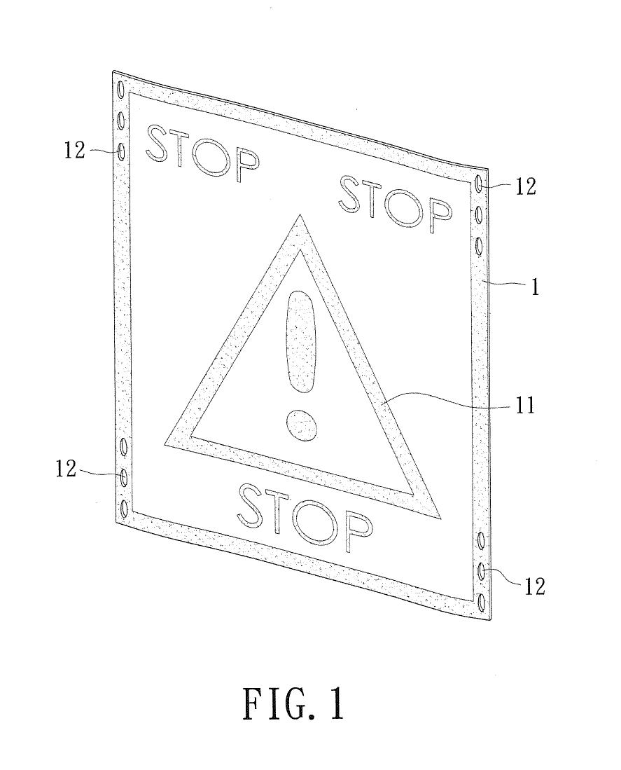

Referring to FIG. 1, a perspective view showing an embodiment of an automobile warming structure according to the present invention is revealed. The automobile warning structure has a blanket body (1) made of a waterproof and warmth retention material. The blanket body (1) has a warning pattern (11) disposed thereon and a plurality of holes (12) disposed on a periphery thereof for fixedly connection with an automobile.

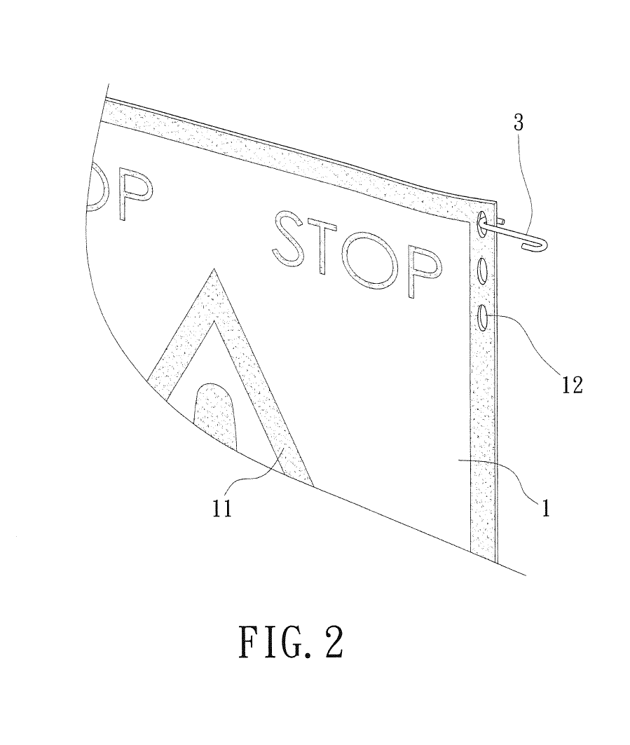

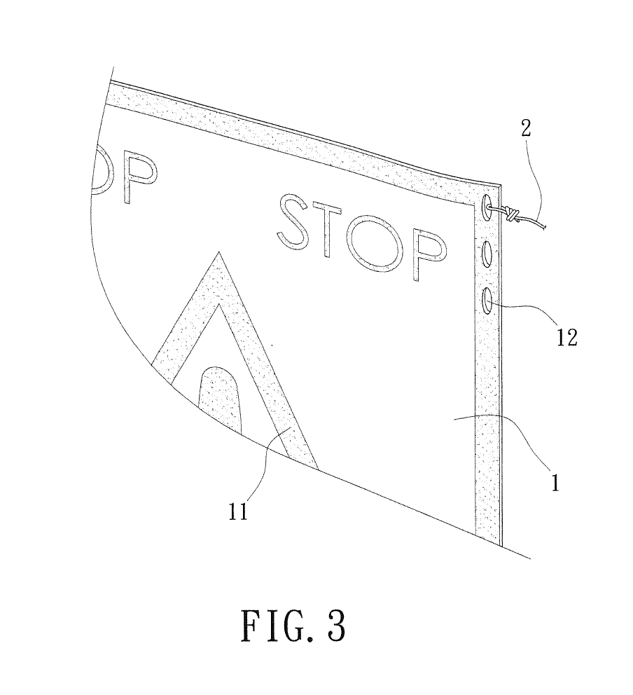

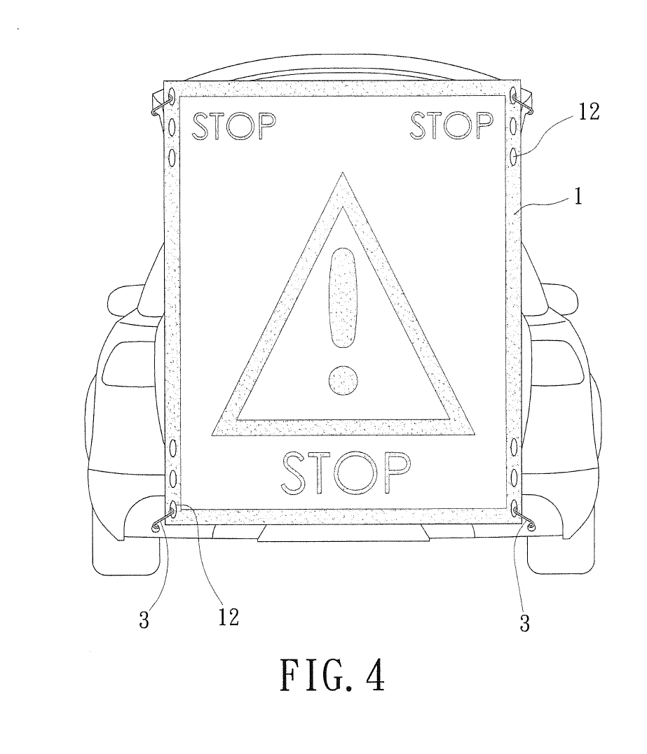

Referring to FIG. 1 to FIG. 4 for practical implementation, when an automobile breaks down on the road or occurs a traffic accident, in order to attract the rear drivers' attention, the driver must open the trunk of the automobile, and then spread out the blanket body (1) to hang on the opening trunk, so that the blanket body (1) covers the entire rear-area of the automobile. It is suitable for every type of automobiles, especially for hatchback cars, because of a higher height of the opened trunk). Then, the blanket body (1) can be fixed on the automobile by the holes (12) on the periphery of the blanket body (1). Therefore, the invention further has a rope (2) or a hook (3), and the blanket body (1) is correspondingly hooked on the trunk or fender of the automobile by passing the rope (2) through the plural holes (12) and combining with the hook (3). The blanket body (1) can also be bound to a support stand of the automobile by the rope (2) only. The blanket body (1) can also be bound to the automobile by passing one end of the hook (3) through the plural holes (12), and the other end of the hook (3) is hooked under a rear bumper, a rear fender, a rear wheel or the like of the automobile. The blanket body (1) can be spread and fixed on the automobile, and the holes (12) of the blanket body (1) is for a user to select the stable and positioning holes to be inserted with the rope (2) or the hook (3), and it has good usability.

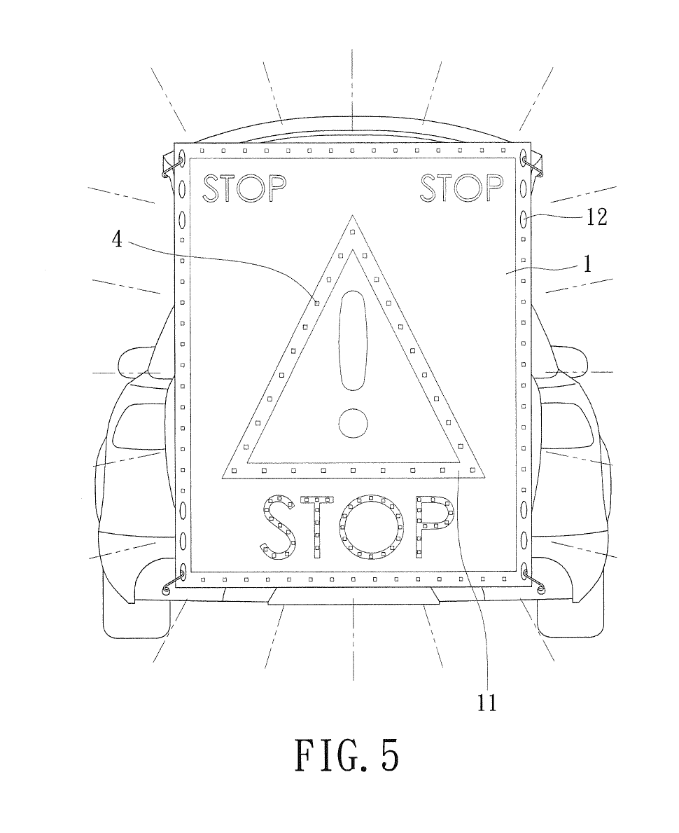

The fixed warning blanket has a quite striking area (about over ten times of the area of a general warning tripod). Accordingly, this invention allows drivers to fully beware of the warning pattern (11) for the purposes of warning and anti-collision. At the same time, light emitting elements (4) are disposed on the blanket body (1), and the light emitting elements (4) illuminate at night or in a dark condition so that the brightness can be improved for attracting much more attention of drivers. (referring to FIG. 5).

In addition to the reminder on anti-collision and the warning signs, the warning blanket of the invention has other purposes as following:

The blanket body (1) is made of the waterproof material, thus it can be used as a raincoat due to its waterproof function when a driver is required to activities in the rain. When a user drives in a cold region or sleeps outdoors, the blanket body (1) can be used as warmth retention clothing due to its warmth retention function.

Furthermore, the blanket body (1) has a second surface, oppose to a first surface on which the warning pattern (11) is disposed, to be printed with commodity patterns for commercial advertisements. Or, the second surface is used as a projection curtain for a projector. In addition, the entire blanket body (1) is used as a cover for covering and protecting the automobile.

What is claimed is:

1. An automobile warning structure, comprising:
a blanket body, made of a waterproof and warmth retention material, and having a first surface on which a warning pattern is disposed and a second surface opposite to the first surface, and having a plurality of holes disposed on a periphery thereof for fixedly connection with an automobile.

2. The automobile warning structure as claimed in claim 1, wherein light emitting elements are disposed on the first surface of the blanket body.

3. The automobile warning structure as claimed in claim 1, wherein the second surface of the blanket body is used as a commercial advertising curtain.

4. The automobile warning structure as claimed in claim 1, wherein the second surface of the blanket body is used as a projection curtain.

5. The automobile warning structure as claimed in claim 2, wherein the second surface of the blanket body is used as a commercial advertising curtain.

6. The automobile warning structure as claimed in claim 2, wherein the second surface of the blanket body is used as a projection curtain.
